(19) United States
(12) Patent Application Publication
(10) Pub. No.: US 2021/0228012 A1
(43) Pub. Date: Jul. 29, 2021

(54) DEVICE, SYSTEM AND METHOD FOR FACILITATING PACKAGE DELIVERY OR PICKUP

(71) Applicant: Vincent Cheng, Burnaby (CA)

(72) Inventor: Vincent Cheng, Burnaby (CA)

(21) Appl. No.: 17/159,215

(22) Filed: Jan. 27, 2021

Related U.S. Application Data
(60) Provisional application No. 62/966,980, filed on Jan. 28, 2020.

(51) Int. Cl. A47G 29/14; G07C 9/00; G07C 9/27

(52) U.S. Cl. CPC A47G 29/141; G07C 9/00309; A47G 2029/149; G07C 9/00912; A47G 2029/144; G07C 9/27

(57) ABSTRACT

A system for facilitating a package delivery at or a pickup from a door assembly of a building structure is provided. |The door assembly may include a door with a thickness, and a door jamb. The door may be hingedly coupled to the door jamb to define a door channel between the door and the door jamb. The system includes a package receiving enclosure, a securing arrangement and a locking assembly. The securing arrangement may be coupled to the package receiving enclosure. The securing arrangement may be adapted to be received in the door channel between the door and the door jamb for detachably coupling the package receiving enclosure to the door assembly of the building structure. Further, the locking assembly may be coupled to the package receiving enclosure to enable locking and unlocking of the package receiving enclosure by an authorized personal.

### CROSS REFERENCE TO RELATED APPLICATIONS

The present invention claims priority under 35 United States Code, Section 119 on the provisional application No. 62/966,980 filed on Jan. 28, 2020, the disclosure of which is incorporated by reference.

### FIELD OF THE INVENTION

The present invention generally relates to parcel management and delivery, and, more particularly, to a package delivery and pick-up system, device and method. The disclosure also relates to mail parcel package anti□thief pop up security safe box apartment multifamily mail package drop off hub delivery system.

### BACKGROUND OF THE INVENTION

Currently, there are a number of solutions for anti□parcel thief porch pirates. Some of these solutions attempt to secure the parcel in a large metal box that is screwed down to the house or large cloth bags that are attached to the front door but these solutions fail to meet the needs of the industry because many people do not have a large porch to install a large box or they live in an apartment and installing a box is a major problem. Many people do not want a large ugly box on their beautiful porch.

Other solutions attempt to detour the thief by acting like shoplifter alarm if the package is removed a high pitch sound will be audible from the security device that is attached to the home. However, these solutions are similarly unable to meet the needs of the industry because people audio is weak cry for help.

Accordingly, there exists a need device or system that can receive a mail parcel when the home owner is not home and hold the parcel securely so the parcel is not stolen.

### SUMMARY OF THE INVENTION

In view of the foregoing disadvantages inherent in the prior art, the general purpose of the present invention is to provide a package delivery and pick-up system, device and method to include all advantages of the prior art, and to overcome the drawbacks inherent in the prior art.

An object of the present disclosure is to provide a device or a system that may receive a mail parcel when the home owner is not home and hold the parcel securely so the parcel is not stolen.

With that regard, in one aspect of the present invention, a system for facilitating a package delivery at or a pickup from a door assembly of a building structure is provided. |The door assembly may include a door with a thickness, and a door jamb. The door may be hingedly coupled to the door jamb to define a door channel between the door and the door jamb. The system includes a package receiving enclosure, a securing arrangement and a locking assembly. The securing arrangement may be coupled to the package receiving enclosure. The securing arrangement may be adapted to be received in the door channel between the door and the door jamb for detachably coupling the package receiving enclosure to the door assembly of the building structure. Further, the locking assembly may be coupled to the package receiving enclosure to enable locking and unlocking of the package receiving enclosure by an authorized personal.

In one embodiment, the system may further include a package receiving/pickup information system, a central server, and at least one hand held device of the authorized personal. The at least one hand held device of the authorized personal may include a delivery/pick-up personal hand-held device or a package owner hand-held device. The package receiving/pickup information system may be associated with the locking assembly. The package receiving/pickup information system may be adapted to be communicably coupled with at least the central server, and the at least one hand held device of the authorized personal to enable locking and unlocking of the package receiving enclosure by the authorized personal.

In one embodiment, the securing arrangement may include a plate structure. The plate structure may include a first portion member, a second portion member and a third portion member. The first portion member may be detachably coupled to the package receiving enclosure. The second portion member may bend from first portion member. Further, the second portion member may define a length that compliments the thickness of the door. Furthermore, the third portion member may also bend from the second portion members. The third portion member may be substantially parallel and shorter in length than the first portion member. The first, second and third portions unitarily defines the plate structure. The second and third portion members may be adapted to be received in the door channel between the door and the door jamb such that the second portion member accommodate the thickness of the door and the third portion member along with the first portion member grips the door grips the door from an inside and an outside of the door for detachably coupling the package receiving enclosure to the door assembly. In certain embodiment, the plate structure may include an attaching member coupled to the plate structure to detachably couple the plate structure to the door. The attaching member may be provided along the second portion member to detachably couple the plate structure to the door.

In one another embodiment, the securing arrangement may include an attaching assembly having a set of screws. The set of screws may pass through the package receiving enclosure and adapted to be screwed in the door along the door channel for detachably coupling the package receiving enclosure to the door assembly.

In yet one another embodiment, the securing arrangement may include at least one chain and anchor assembly. The at least one chain and anchor assembly may include a chain member and an anchor member. The chain member may include a first end portion and a second end portion. The first end portion may be coupled to the package receiving enclosure. Further, the anchor member may be coupled to the second end portion of the chain member. The chain member may be adapted to be received in the door channel such that the anchor member may be disposed inside of the door assembly and the door act as stoppage for the anchor member for detachably coupling the package receiving enclosure to the door assembly.

In one embodiment of the present disclosure, the package receiving enclosure may be expandable to accommodate a package for delivery or pickup.

In one arrangement, the package receiving enclosure may include a receptacle member and an expandable bag member. The receptacle member may include an enclosing space. Further, the expandable bag member may be disposed within the receptacle member. The expandable bag member may be configured to expand to receive a package for delivery or pickup.

In one arrangement of the present disclosure, the expandable bag member may be adapted to be expanded upwardly from within the receptacle member to be expanded to receive the package for delivery or pickup. In one another arrangement of the present disclosure, the expandable bag member may be adapted to be expanded dropped downwardly from within the receptacle member to be expanded to receive the package for delivery or pickup.

In one embodiment of the present disclosure, the expandable bag member may include a free□flowing looped-cable structure and a locking structure. The free□flowing looped-cable structure may include a plurality of looped-cables, a supporting structure and a locking structure. The plurality of looped-cables may be interlocked with each other to define a free-flowing enclosure. The supporting structure may include one or more support member. The plurality of looped-cables may be coupled to the one or more support member to obtain the expandable bag member. The locking structure may be coupled to the free-flowing looped-cable structure. The locking structure may lock the free-flowing enclosure from an unauthorized access.

In one embodiment of the present disclosure, the locking structure may be a free-floating locking structure having a lock member.

In one embodiment of the present disclosure, the receptacle member may include a first enclosure member and a second enclosure member. The second enclosure member may pivotally be coupled to the first enclosure member to define the enclosing space.

In one embodiment of the present disclosure, the receptacle member may include an expandable structure adapted to expand a size of the receptacle member to accommodate a package for delivery or pickup. The expandable structure may be adapted to expand the size of the receptacle member at least from one of a side, a top and a front of the receptacle member to accommodate the package for delivery or pickup.

In one another aspect of the present invention, a package receiving device is provided. The package receiving device may facilitate package delivery at or pickup from a door assembly of a building structure. The door assembly may include a door with a thickness, and a door jamb, the door hingedly may be coupled to the door jamb to define a door channel between the door and the door jamb. The system includes a package receiving enclosure, a securing arrangement and a locking assembly. The securing arrangement may be coupled to the package receiving enclosure. The securing arrangement may be adapted to be received in the door channel between the door and the door jamb for detachably coupling the package receiving enclosure to the door assembly of the building structure. Further, the locking assembly may be coupled to the package receiving enclosure to enable locking and unlocking of the package receiving enclosure by an authorized personal.

In one embodiment, the package receiving device may further includes a package receiving/pickup information system associated with the locking assembly.

In one embodiment of the present disclosure, the securing arrangement may include a plate structure a plate structure. The plate structure may include a first portion member, a second portion member and a third portion member. The first portion member may be detachably coupled to the package receiving enclosure. The second portion member may bend from first portion member. Further, the second portion member may define a length that compliments the thickness of the door. Furthermore, the third portion member may also bend from the second portion members. The third portion member may be substantially parallel and shorter in length than the first portion member. The first, second and third portions unitarily defines the plate structure. The second and third portion members may be adapted to be received in the door channel between the door and the door jamb such that the second portion member accommodate the thickness of the door and the third portion member along with the first portion member grips the door grips the door from an inside and an outside of the door for detachably coupling the package receiving enclosure to the door assembly. In certain embodiment, the plate structure may include an attaching member coupled to the plate structure to detachably couple the plate structure to the door. The attaching member may be provided along the second portion member to detachably couple the plate structure to the door.

In one another embodiment, the securing arrangement may include an attaching assembly having a set of screws. The set of screws may pass through the package receiving enclosure and adapted to be screwed in the door along the door channel for detachably coupling the package receiving enclosure to the door assembly.

In yet one another embodiment, the securing arrangement may include at least one chain and anchor assembly. The at least one chain and anchor assembly may include a chain member and an anchor member. The chain member may include a first end portion and a second end portion. The first end portion may be coupled to the package receiving enclosure. Further, the anchor member may be coupled to the second end portion of the chain member. The chain member may be adapted to be received in the door channel such that the anchor member may be disposed inside of the door assembly and the door act as stoppage for the anchor member for detachably coupling the package receiving enclosure to the door assembly.

In one embodiment of the present disclosure, the package receiving enclosure may be expandable to accommodate a package for delivery or pickup. In such embodiment, the package receiving enclosure may include a receptacle member and an expandable bag member. The receptacle member may include an enclosing space. Further, the expandable bag member may be disposed within the receptacle member. The expandable bag member may be configured to be expanded to receive a package for delivery or pickup. In one arrangement, the expandable bag member may be a free□flowing looped-cable structure that includes a plurality of looped-cables, a supporting structure, and a locking structure. The plurality of looped-cables may be interlocked with each other to define a free-flowing enclosure. Further, the supporting structure may include a plurality of rod and frame members. The plurality of looped-cables may be coupled with the rod and frame members to obtain the expandable bag member. Furthermore, the locking structure may be coupled to the free-flowing looped-cable structure. The locking structure may lock the free-flowing enclosure from an unauthorized access. The expandable bag member may be adapted to be expanded upwardly or dropped downwardly from within the receptacle member to be expanded to receive the package for delivery or pickup.

The package delivery and pick-up system, device and method as disclosed are configured to receive a mail parcel when the home owner is not home and hold the parcel securely so the parcel is not stolen. The device may be small in size but can expand to accommodate and hold bigger boxes. Further, most people do not have enough space in front of their door to accommodate a large security box as they may live in an apartment or they do not want a large box in front of their door. In such scenario such device is very useful. Still, further, the device works for all types of housing types from larges homes to high rise apartments and businesses. The disclosed device has the ability to collapse into a smaller unit and be discrete.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates, a system for facilitating a package delivery at or a pickup from a door assembly of a building structure, in accordance with an exemplary embodiment of the present disclosure;

FIG. 2 illustrates a package receiving device assembled to the door assembly, in accordance with an exemplary embodiment of the present disclosure;

FIG. 2A illustrates the package receiving device in accordance with an exemplary embodiment of the present disclosure;

FIGS. 2B and 2C illustrates a securing arrangement of the package receiving device of FIG. 2A, in accordance with an exemplary embodiment of the present disclosure;

FIG. 2D illustrates a package receiving device of FIG. 2A opened to show a package receiving enclosure, in accordance of one exemplary embodiment of the present disclosure;

FIG. 3 illustrates a package receiving device assembled to the door assembly, in accordance with another exemplary embodiment of the present disclosure;

FIG. 3A illustrates a securing arrangement adapted to assemble the package receiving device of FIG. 3, in accordance with an exemplary embodiment is disclosed.

FIG. 4 illustrates a package receiving device assembled to the door assembly, in accordance with another exemplary embodiment of the present disclosure;

FIG. 4A illustrates a package receiving device and a securing arrangement of FIG. 4 depicting a chain and anchor assembly, in accordance with another exemplary embodiment of the present disclosure.

FIG. 4B illustrates a package receiving device along with two chain and anchor assembly 230 to couple the package receiving enclosure 100 with the door assembly, in accordance with another exemplary embodiment of the present disclosure.

FIG. 4C illustrates a side view of an arrangement of the package receiving device with the door, in accordance with another exemplary embodiment of the present disclosure.

FIG. 5 illustrates a package receiving device assembled to the door assembly, in accordance with further exemplary embodiment of the present disclosure;

FIG. 6A illustrates an expandable bag member in dropped state from a package receiving device, in accordance with further exemplary embodiment of the present disclosure;

FIG. 6B illustrates a top view of an expandable bag member, in accordance with further exemplary embodiment of the present disclosure;

FIGS. 7A to 7D illustrate the free□flowing looped-cable structure with the plurality of looped-cables, in accordance with various embodiments of the present disclosure;

FIGS. 7E to 7H illustrate various arrangements of the plurality of looped-cables with respect to the supporting structure including various rod and frame members, in accordance with various embodiments of the present disclosure;

FIGS. 7I to 7L illustrates steps for folding the free□flowing looped-cable structure in accordance with an exemplary embodiment of the present disclosure;

FIGS. 8A and 8B illustrate flatten top views of the free□flowing looped-cable structure, in accordance with various embodiment of the present disclosure;

FIGS. 9A and 9B, respectively, illustrate a free-floating locking structure in an unlocked state and in locked-state, in accordance with various embodiment of the present disclosure;

FIGS. 10A and 10B, respectively, illustrates an expandable bag member expanded downwardly and upwardly with respect to a door assembly, in accordance with various exemplary embodiment of the present disclosure;

FIGS. 11A to 11C illustrate a package receiving device coupled to the door in opened state, and with the free□flowing looped-cable structure, in accordance with various exemplary embodiment of the present disclosure;

FIGS. 12A and 12B respectively illustrate an expandable receptacle member in a collapsed state and in an expanded state, in accordance with various exemplary embodiment of the present disclosure;

FIG. 12C illustrates an expandable receptacle member with an expandable bag member, in accordance with various exemplary embodiment of the present disclosure;

FIGS. 13A and 13B respectively illustrate an expandable receptacle member in a collapsed state and in an expanded state, in accordance with another exemplary embodiment of the present disclosure;

FIG. 14 illustrates an expandable receptacle member in an expanded state, in accordance with yet another exemplary embodiment of the present disclosure;

FIGS. 15A and 15B illustrate an expandable receptacle member in a collapsed state and in an expanded state, in accordance with yet another exemplary embodiment of the present disclosure; and

FIGS. 16A to 16B respectively illustrate a locking assembly in a locked state and in an unlocked state, in accordance with various embodiments;

FIG. 16C illustrates a locking assembly in a locked state, in accordance with various embodiments.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The terms, “a” and “an” herein do not denote a limitation of quantity, but rather denote the presence of at least one of the referenced items.

In one aspect of the present invention, a system for facilitating a package delivery at or a pickup from a door assembly of a building structure is provided. |The door assembly may include a door with a thickness, and a door jamb. The door may be hingedly coupled to the door jamb to define a door channel between the door and the door jamb. The system includes a package receiving enclosure, a securing arrangement and a locking assembly. The securing arrangement may be coupled to the package receiving enclosure. The securing arrangement may be adapted to be received in the door channel between the door and the door jamb for detachably coupling the package receiving enclosure to the door assembly of the building structure. Further, the locking assembly may be coupled to the package receiving enclosure to enable locking and unlocking of the package receiving enclosure by an authorized personal.

In one another aspect of the present invention, a package receiving device is provided. The package receiving device may facilitate package delivery at or pickup from a door assembly of a building structure. The door assembly may include a door with a thickness, and a door jamb, the door hingedly may be coupled to the door jamb to define a door channel between the door and the door jamb. The system includes a package receiving enclosure, a securing arrangement and a locking assembly. The securing arrangement may be coupled to the package receiving enclosure. The securing arrangement may be adapted to be received in the door channel between the door and the door jamb for detachably coupling the package receiving enclosure to the door assembly of the building structure. Further, the locking assembly may be coupled to the package receiving enclosure to enable locking and unlocking of the package receiving enclosure by an authorized personal.

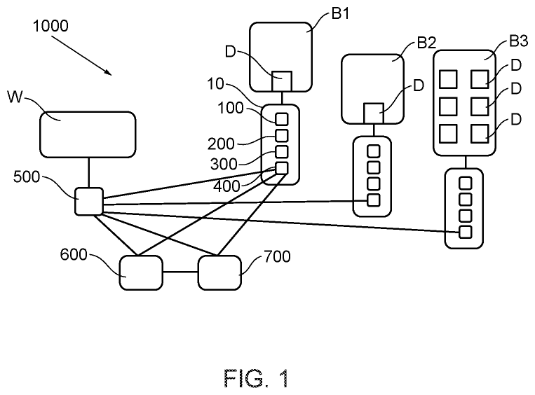

Referring now to FIG. 1, a system 1000 for facilitating a package delivery at or a pickup from a door assembly ‘D’ of a building structure, such as inside of the building structure ‘B1’, outside of the building structure ‘B2’, and a high-rise building structure ‘B3’, is illustrated in accordance with an exemplary embodiment of the present disclosure.

The system 1000 includes a package receiving device 10 having a package receiving enclosure 100, a securing arrangement 200 and a locking assembly 300. The securing arrangement 200 is coupled to the package receiving enclosure 100. Further, the locking assembly 300 is also coupled to the package receiving enclosure 100. Further, in one embodiment of the present disclosure, the package receiving device 10 may also include a package receiving/pickup information system 400 associated with the locking assembly 300.

Further, as shown in FIG. 1, the system 1000 may further include a central server 500, and at least one hand held device 600, 700 of authorized personals. In an example, the at least one hand held device 600, 700 of the authorized personal may include a delivery/pick-up personal hand-held device 600 or a package owner hand-held device 700. The central server 500 may be communicably coupled to a warehouse ‘W’ from where the package is picked-up for delivery at various door assemblies ‘D’ of the building structures ‘B1’, ‘B2’ and ‘B3’. Further, the package receiving/pickup information system 400 may also be communicably coupled with the central server 500. Furthermore, the at least one hand held device of the authorized personal, such as the delivery/pick-up personal hand-held device 600 and the package owner hand-held device 700 may also be communicably coupled to the package receiving/pickup information system 400 and the central server 500. Preferably, the central server 500, the package receiving/pickup information system 400, the delivery/pick-up personal hand-held device 600 and the package owner hand-held device 700 form a communication mesh in order to communicate with each other to enable locking and unlocking of the package receiving enclosure by the authorized personal for successfully delivering and pick-up of the package in and from the package receiving device 10.

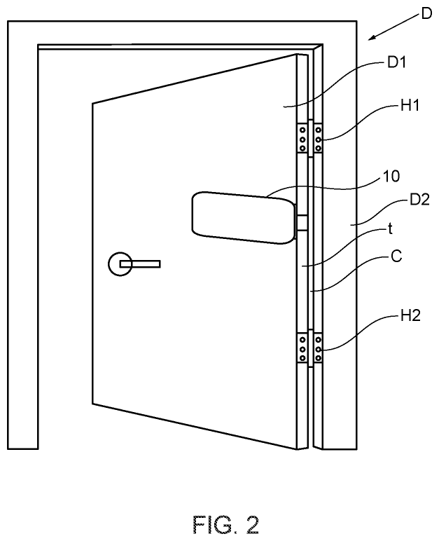

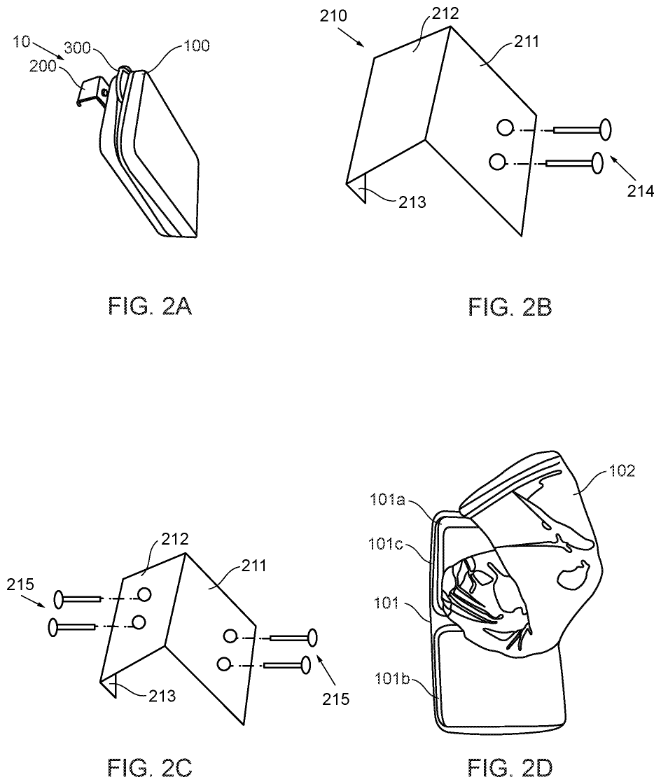

Referring now to FIGS. 2 to 2D, the package receiving device 10, according to one embodiment will now be described. As shown in FIG. 2, the package receiving device 10 may be assembled to the door assembly ‘D’. The door assembly ‘D’ may include a door ‘D1’ with a thickness ‘t’, and a door jamb ‘D2’. The door ‘D1’ is hingedly ‘H1’ and ‘H2’ coupled to the door jamb ‘D2’ to define a door channel ‘C’ between the door ‘D1’ and the door jamb ‘D2’.

FIG. 2A illustrates the package receiving device 10 in accordance with an exemplary embodiment of the present disclosure, and will be described herein in conjunction with FIGS. 1 and 2. The package receiving device 10, as shown in FIG. 2A, includes the package receiving enclosure 100, the securing arrangement 200 and the locking assembly 300. The securing arrangement 200 may be coupled to the package receiving enclosure 100. Further, the locking assembly 300 may also be coupled to the package receiving enclosure 100 Further, the locking assembly 300 may be coupled to the package receiving enclosure 100 to enable locking and unlocking of the package receiving enclosure 100 by an authorized personal. As shown in FIGS. 2 and 2A, the securing arrangement 200 may be adapted to be received in the door channel ‘C’ between the door ‘D1’ and the door jamb ‘D2’ for detachably coupling the package receiving enclosure 100 to the door assembly ‘D’ of the building structure ‘B1’, ‘B2’ or ‘B3’.

Referring now to FIG. 2B and 2C, in one embodiment of the present disclosure, the securing arrangement 200 may be described in according with one example arrangement. The securing arrangement 200, in one arrangement, as shown in FIGS. 2B and 2C and described in combination with FIG. 2, may include a plate structure 210. The plate structure 210 may include a first portion member 211, a second portion member 212, and a third portion member 213. The first portion member 211 may detachably be coupled to the package receiving enclosure 100 via a screw set 214. The second portion member 212 may bend from first portion member 211. The second portion member 212 may define a length that compliments the thickness ‘t’ of the door ‘D1’, as shown in FIG. 2. Further the third portion member 213 may bend from the second portion member 212. The third portion member 213 may be substantially parallel and shorter in length than the first portion member 211. However, without departing from the scope of the present disclosure, the first portion member 211 and the third portion member 213 may not necessarily be parallel to each other, or that the third portion member 213 may not necessarily be shorter in length than the first portion member 211. The length and the arrangement of the first portion member 211 and the third portion member 213 with respect to each other may be selected as per the requirement. The first, second and third portion members 211, 212, 213 unitarily defines the plate structure 210. In one example form, as shown in FIGS. 2B and 2C, the plate structure 210 may be made from a single metal piece, wherein such metal piece is bent to obtain the first portion member 211, the second portion member 212, and the third portion member 213. However, without departing from the scope of the present disclosure, the plate structure 210 may be made from multiple metal pieces, wherein each such metal pieces are joint or welded to obtain the plate structure 210 having the first portion member 211, the second portion member 212, and the third portion member 213.

The second and third portion members 212, 213 may be adapted to be received in the door channel ‘C’ between the door ‘D1’ and the door jamb ‘D2’ such that the second portion member 212 accommodates the thickness ‘t’ of the door ‘D1’, and the third portion member 213 along with the first portion member 211 grip the door ‘D1’ from an inside and an outside of the door ‘D1’ for detachably coupling the package receiving enclosure 100 to the door assembly ‘D’.

In one arrangement, the plate structure 210 may include an attaching member in a form of a screw set 215. Such attaching member may be coupled to the plate structure 210 to detachably couple the plate structure 210 to the door ‘D1’. The attaching member 215 may be provided along the second portion member 212 to detachably couple the plate structure 210 to the door ‘D1’.

Referring now to FIG. 2D, the package receiving enclosure 100 will be described, in accordance of one exemplary embodiment of the present disclosure. In one example arrangement, package receiving enclosure 100 is expandable to accommodate a package for delivery or pickup. As shown in FIG. 2D, the package receiving enclosure 100 includes a receptacle member 101 and an expandable bag member 102 disposed within the receptacle member 101. In one example the receptacle member 101 may be formed by two enclosing members 101a, 101b pivotally coupled to define an enclosing space 101c. The enclosing members 101a, 101b may be include a closable/openable member, such as zipper, Velcro, and so forth to open and close the receptacle member 101 to access the expandable bag member 102. The expandable bag member 102 may be configured to be expanded to receive the package for delivery or pickup as will be described in details herein later.

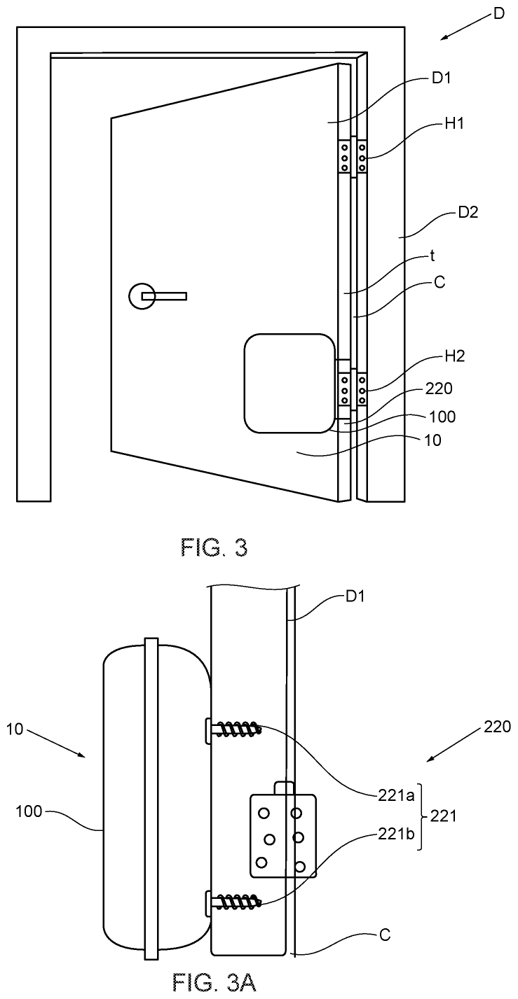

Referring now to FIGS. 3 and 3A, a securing arrangement, such as a securing arrangement 220, is illustrated, in accordance with another exemplary embodiment. The securing arrangement 220 of this embodiment may include an attaching assembly 221 having a set of screws 221a, 221b. The set of screws 221a, 221b passes through the package receiving enclosure, such as the package receiving enclosure 100, and adapted to be screwed in the door ‘D1’ along the door channel ‘C’ for detachably coupling the package receiving enclosure 100 to the door assembly ‘D’.

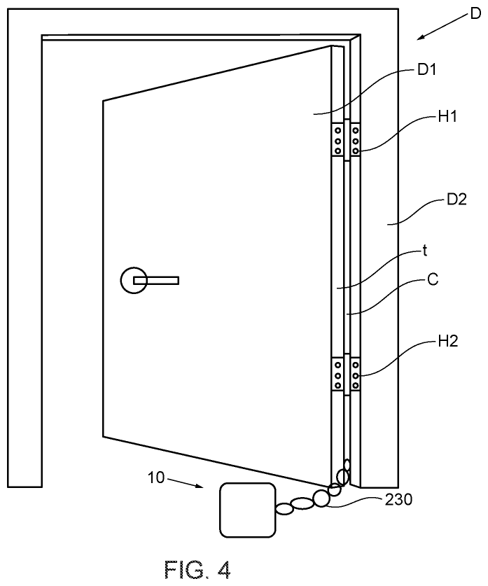

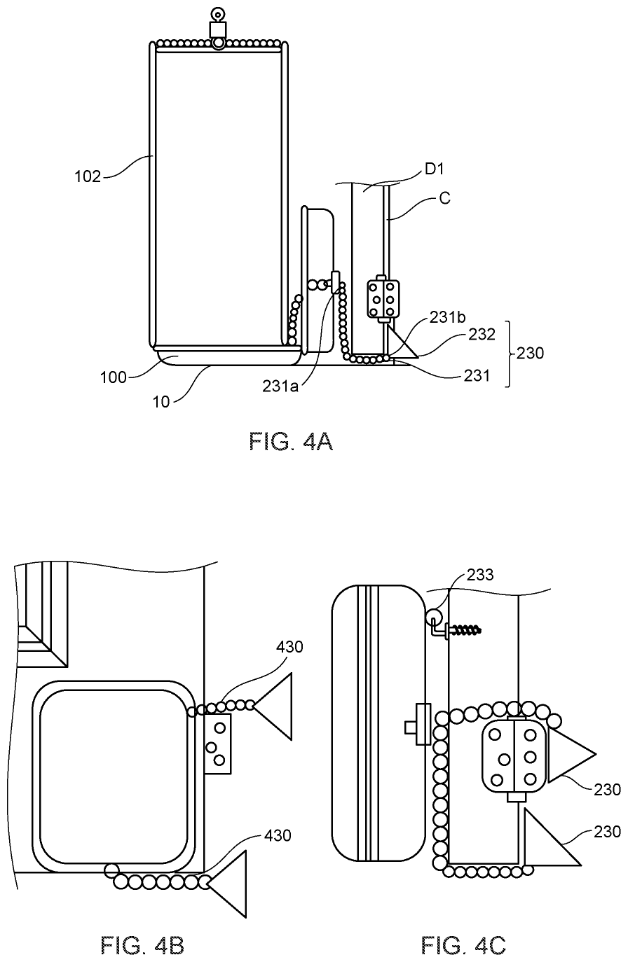

Referring now to FIGS. 4 to 4D, a securing arrangement, such as a securing arrangement 230, in accordance with another exemplary embodiment is disclosed. As shown in FIGS. 4 and 4A, the securing arrangement 230 of this embodiment may include at least one chain and anchor assembly 232. The at least one chain and anchor assembly 230 may include a chain member 231 and an anchor member 232, The chain member 231 may include a first end portion 231a and a second end portion 231b. The first end portion 231a may be coupled to the package receiving enclosure 100. Further, the anchor member 232 may be coupled to the second end portion 231b of the chain member 231. The chain member 231 may be adapted to be received in the door channel ‘C’ such that the anchor member 232 may be disposed inside of the door assembly ‘D’ and the door ‘D1’ act as stoppage for the anchor member 232 for detachably coupling the package receiving enclosure 100 to the door assembly ‘D’. As shown in FIG. 4A, the package receiving enclosure 100 may include an expandable bag member, such as the expandable bag member 102, that may be configured to be expanded to receive the package for delivery or pickup as will be described in details herein later.

Further, as shown in FIGS. 4B and 4C, the chain and anchor assembly 230 may be coupled to the package receiving enclosure 100 in many ways. As shown in FIG. 4B, two chain and anchor assembly 230 may be used to couple the package receiving enclosure 100 with the door assembly ‘D’. Further, as shown in FIG. 4C illustrates a side view of the arrangement, wherein the package receiving enclosure 100 may be coupled to the door assembly ‘D’ via two chain and anchor assembly 230 and may also include another coupling member 233, for example, screw or bolt, to rigidly couple the package receiving enclosure 100 with the door assembly ‘D’.

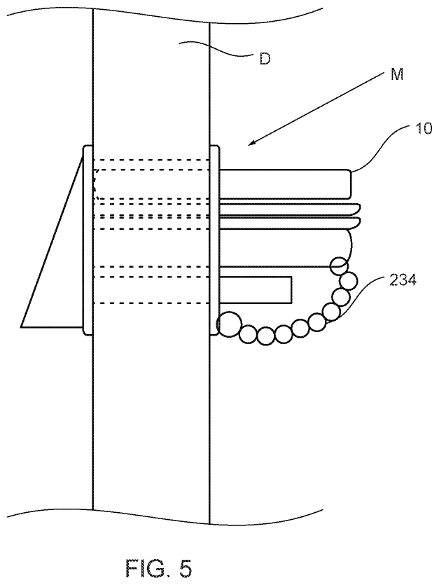

Referring now to FIG. 5, in one additional exemplary embodiment of the present disclosure, the package receiving device 10 may also be coupled to the door assembly ‘D’ via a mail slot ‘M’ incorporated in the door ‘D1’, and chain assembly 234. In such arrangement, the package receiving device 10 may be partially disposed within the mail slot ‘M’ and the chain assembly 234, from its one end may be coupled to the package receiving device 10, and from its other end, may be coupled to the door ‘D1’.

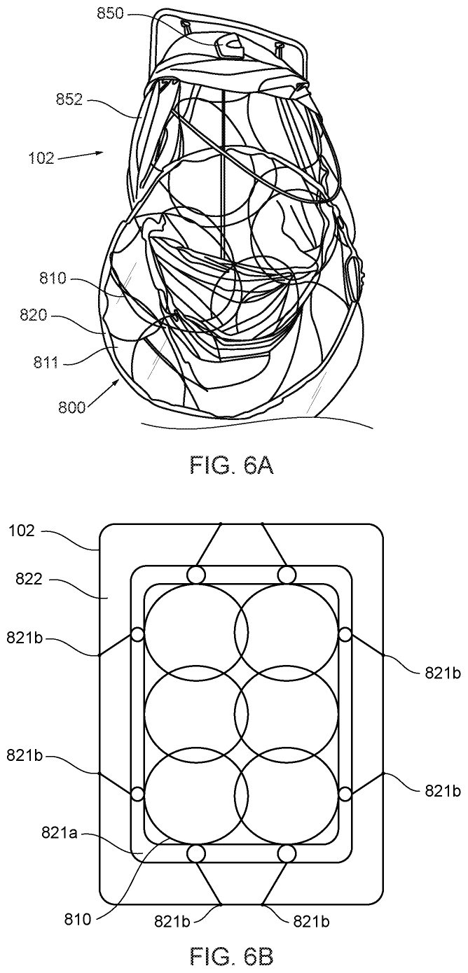

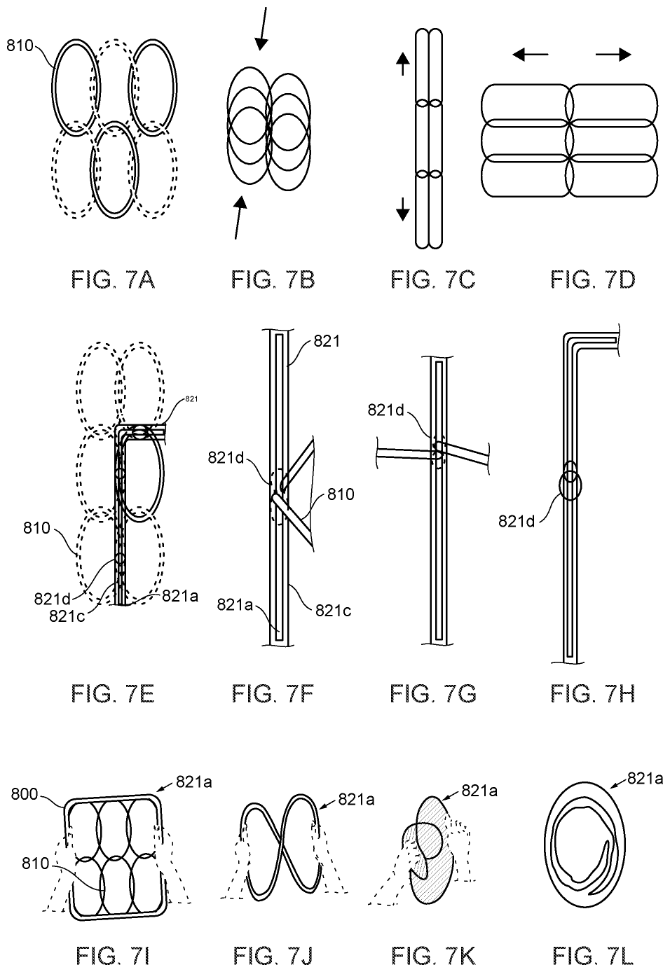

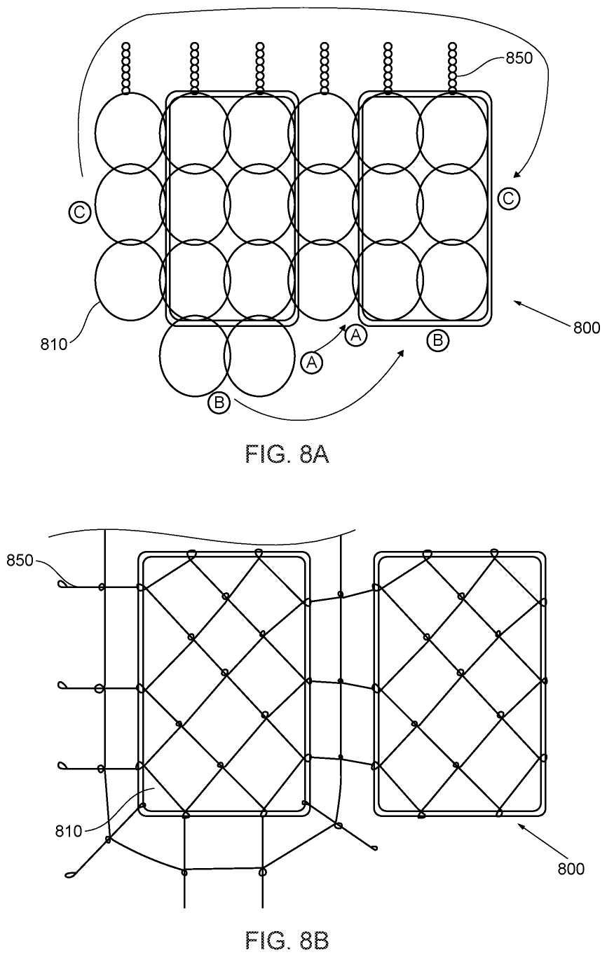

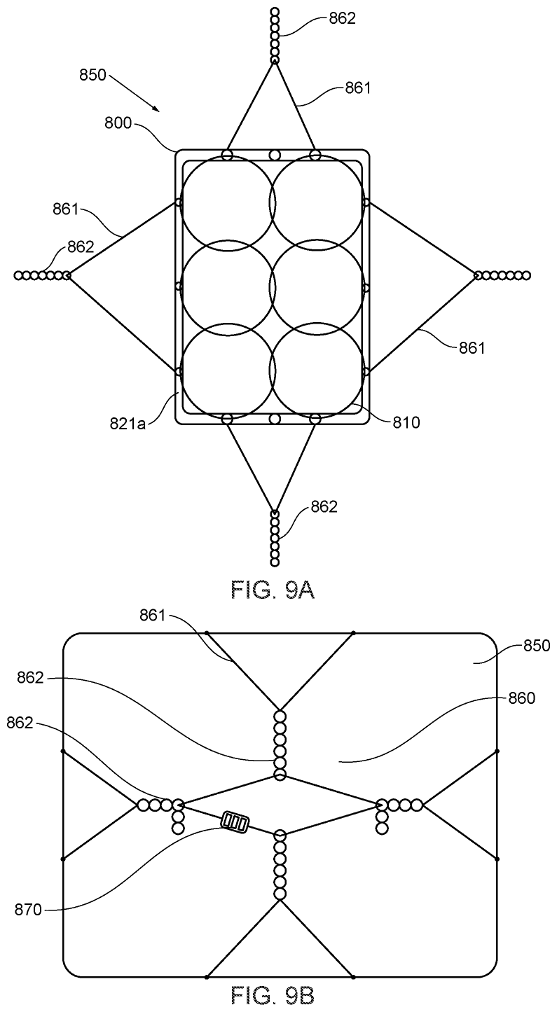

Referring now to FIGS. 6A and 6B to describe the expandable bag member 102, in accordance with an exemplary embodiment of the present disclosure. FIG. 6A illustrates the expandable bag member 102 in dropped state from the package receiving device 10. FIG. 6B illustrates a top view of the expandable bag member 102. The expandable bag member 102 may include a free□flowing looped-cable structure 800 and a locking structure 850. The free□flowing looped-cable structure 800 may include a plurality of looped-cables 810 and a supporting structure 820. The free□flowing looped-cable structure 800 will be described herein in reference to FIGS. 7A to 7L and FIGS. 8A to 8B. The plurality of looped-cables 810 interlocked with each other to define a free-flowing enclosure 811. The supporting structure 821 may include various rod and frame members 821a to support the plurality of looped-cables 810 to configure the free-flowing enclosure 811. In one embodiment, the plurality of looped-cables 810 may be coupled to the various rod and frame members 821a of the supporting structure 820 via a clasping member 821b, or may be bi-lopped with the various rod and frame members 821a for coupling therewith. In certain embodiment, the plurality of looped-cables 810 may be surrounded by a suitable fabric enclosure 822. the Further, the free□flowing looped-cable structure 800 may also include the locking structure 850 coupled to thereto. The locking structure 850 may lock the free-flowing enclosure 811 from an unauthorized access. The locking structure 850 will be described herein in reference to FIGS. 9A and 9B.

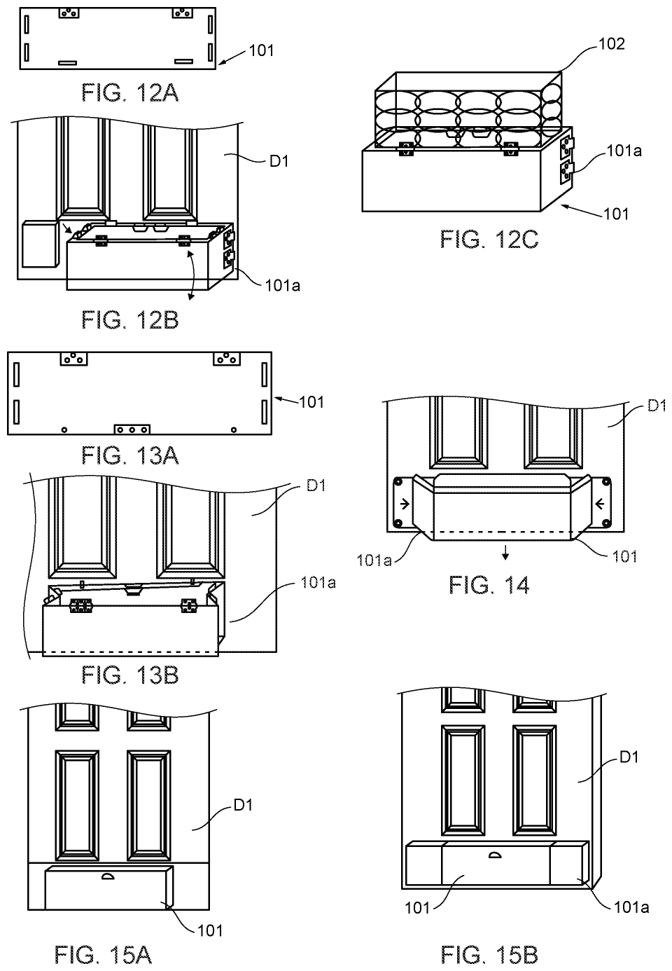

In certain embodiments, the expandable bag member 102 may itself be expandable will be described herein in reference to FIGS. 12A and 15B.

Referring now to FIGS. 7A to 7D, various arrangements are illustrated with respect to the free□flowing looped-cable structure 800 having the plurality of looped-cables 810. As shown in FIG. 7A, the plurality of looped-cables 810 are interlinked to each other. FIG. 7B illustrates, such plurality of looped-cables 810 may be contracted to squeeze the size of the free□flowing looped-cable structure 800 for storing the expandable bag member 102 in the package receiving enclosure 100. FIGS. 7C and 7D illustrate, such plurality of looped-cables 810 may be stretched to expand the size of the free□flowing looped-cable structure 800 to accommodate the size of delivery packages or parcels.

Referring now to FIGS. 7E to 7H, various arrangements of the plurality of looped-cables 810 with respect to the supporting structure 821 including various rod and frame members 821a are illustrated. As shown in FIG. 7E, the supporting structure 821 provided with the rod and frame members 821a made of metal wire and are covered with a cord cover 821c. The cord covers 821c may include holes 821d so the linked loops 810 may by-pass or sandwiched metal by the rod and frame members 821a to engage with the metal rod and frame members 821a.

Referring now to FIGS. 7I to 7L, wherein steps for folding the free□flowing looped-cable structure 800 are illustrated in accordance with an exemplary embodiment of the present disclosure. At step 1, shown in FIG. 7I, a user may hold the rod and frame members 821a at the end with both hands and twist thereto. Further, as step 2, as shown in FIGS. 7J and 7K, the user may twist the rod and frame members 821a and push thereto into itself, forming a circle disk like structure as shown in FIG. 7L.

Referring now to FIGS. 8A and 8B, flatten top views of the free□flowing looped-cable structure 800 are illustrated, in accordance with various embodiment of the present disclosure. As shown in FIG. 8A.

The FIGS. 8A and 8B show all the side of the free□flowing looped-cable structure 800, however, more than or less than three sides may be included in the free□flowing looped-cable structure 800. As shown in FIG. 8A, three linked looped 810 may be a side walls of the free□flowing looped-cable structure 800. The six linked loops 810 may be front and back walls. The 2 linked loops 810 may be a bottom of the free□flowing looped-cable structure 800 with the locking structure 850. The side ‘A’ may swing and connect to the side ‘C’. the side ‘B’ meets with the other side ‘B’. Further, side ‘A’ will meet other side ‘A’, forming the expandable bag member 102. Further, as shown in FIG. 8B, a flatten view of the free□flowing looped-cable structure 800 with straight diamond netting is illustrated, wherein sided thereof may connect as described, to form free□flowing looped-cable structure 800 with the locking structure 850.

Referring now to FIGS. 9A and 9B, the locking structure 850 is described in accordance with an exemplary embodiment of the present disclosure. As shown in FIGS. 9A and 9B, the locking structure 850 may be a free-floating locking structure 860 having a lock member 870. FIG. 9A illustrates the free-floating locking structure 860 in an unlocked state, FIG. 9B illustrates the free-floating locking structure 860 in locked-state, locked via the lock member 870. The free-floating locking structure 860 may include flexible claws wires 861 extending from all the sided of the rod and frame members 821a, and a chain link 862 further extend from all the flexible claws wires 861. As shown in FIG. 9A, the expandable bag member 102 may be expanded by the expanding free□flowing looped-cable structure 800, and after a delivery person place the package or the parcel in the expandable bag member 102, the flexible claws wires 861 along with the chain link 862 are bought together and tied and locked by the lock member 870, as shown in FIG. 9B.

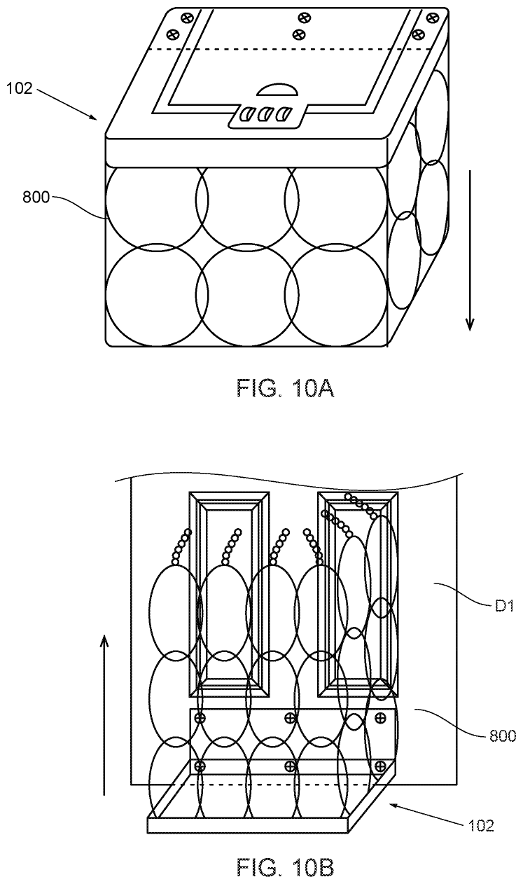

Referring now to FIGS. 10A and 10B, the expandable bag member 102 is, respectively, shown to be expanded downwardly and upwardly with respect to door assembly ‘D’, in accordance with various exemplary embodiment of the present disclosure. As shown in FIG. 10A, the expandable bag member 102 (or the free□flowing looped-cable structure 800) expands downwardly from within the receptacle member 101 with respect to door assembly ‘D’ to be expanded to receive the package for delivery or pickup. Further shown in FIG. 10B, the expandable bag member 102 (the free□flowing looped-cable structure 800) expands upwardly from within the receptacle member 101 with respect to door assembly ‘D’ to be expanded to receive the package for delivery or pickup. Such downward and upward expansion of the expandable bag member 102 (or the free□flowing looped-cable structure 800) may be arranged with respect to the package receiving device 10 as described above. However, in certain embodiment, the package receiving device 10 may be coupled on a panel of the door ‘D1’, and in such embodiment, such downward and upward expansion of the expandable bag member 102 (or the free□flowing looped-cable structure 800) may be arranged with respect to the package receiving device 10.

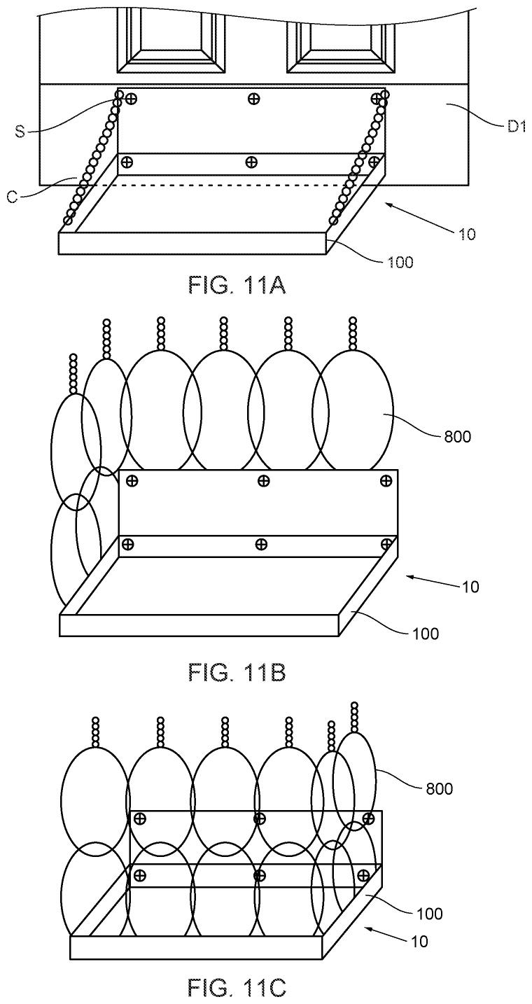

As mentioned, in certain embodiment, the package receiving device 10 may be coupled on a panel of the door ‘D’. One such arrangement is illustrated in FIGS. 11A to 11C. As shown in FIG. 11A, the package receiving device 10 is coupled to the door D1 and is in opened state. In such arrangement, one of a panel member of the package receiving enclosure 100 may be coupled to the door D1 via screws ‘S’, and a chain link ‘L’ is coupled to the such panel member to hold remaining portion of the package receiving enclosure 100. FIG. 11B, illustrates the free□flowing looped-cable structure 800 coupled to such package receiving enclosure 100 along two sides, back and one side. FIG. 11C, illustrates the free□flowing looped-cable structure 800 coupled to such package receiving enclosure 100 along two sides, front and one side.

In certain embodiments, the receptacle member 101 may also be expandable along with the expandable bag member 102 of the package receiving enclosure 100. The receptacle member 101 may be expanded at least from one of a side, a top and a front of the receptacle member 101 to accommodate the package for delivery or pickup. In certain embodiments, the receptacle member 101 may also include an expandable structure, such as an expandable structure 101a as shown in FIGS. 12A, 15A, 16 and 17.

As shown in FIGS. 12A and 12B, the receptacle member 101 may be coupled to the door ‘D1’ along with one of the panels directly coupled with the door ‘D1’ (as shown in FIG. 12A) while other panels are hingedly coupled to the panel which is coupled to the door ‘D1’. Hingedly coupling may act as the expandable structure 101a that may be expanded outwardly (as shown by arrow) from the door ‘D1’, as shown in FIG. 12B. In such arrangement, the receptacle member 101 may be capable of accommodating packages of smaller sizes, and in such cases, unless required, the expandable bag member 102 may not be required to be opened for receiving the packages, and if required, the expandable bag member 102 may be opened for receiving the packages, as shown in FIG. 12C.

Further, as shown in FIGS. 13A and 13B, the receptacle member 101 may be coupled to the door ‘D1’ along with one of the panels directly coupled with the door ‘D1’ (as shown in FIG. 13A) while other panels are coupled to the panel which is coupled to the door ‘D1’ and may expanded outwardly from the door ‘D1’ by extending sides of the receptacle member 101, as shown in FIG. 13B. Herein, extendable sides of the receptacle member 101 acts as the expandable structure 101a. Further, another type of arrangement of the receptacle member 101 may be provided as shown in FIG. 14, wherein a single panel with multi-fold may be directly coupled to the door ‘D’. Such single panel with multi-fold may be pulled from the door ‘D’ to form the receptacle member 101, in which the door ‘D’ acts are one of a side of such receptacle member. Herein, single panel with multi-fold forming the receptacle member 101 acts as the expandable structure 101a.

Further, as shown in FIGS. 15A and 15B, the receptacle member 101 comprises an expandable structure 101a adapted to expand a size of the receptacle member 101 to accommodate a package for delivery or pickup. The expandable structure 101a may be expanded to increase the size of the receptacle member 101 at least from one of a side, a top and a front of the receptacle member 101 to accommodate the package for delivery or pickup. As shown in FIG. 15B, sides of the receptacle member 101 are expanded.

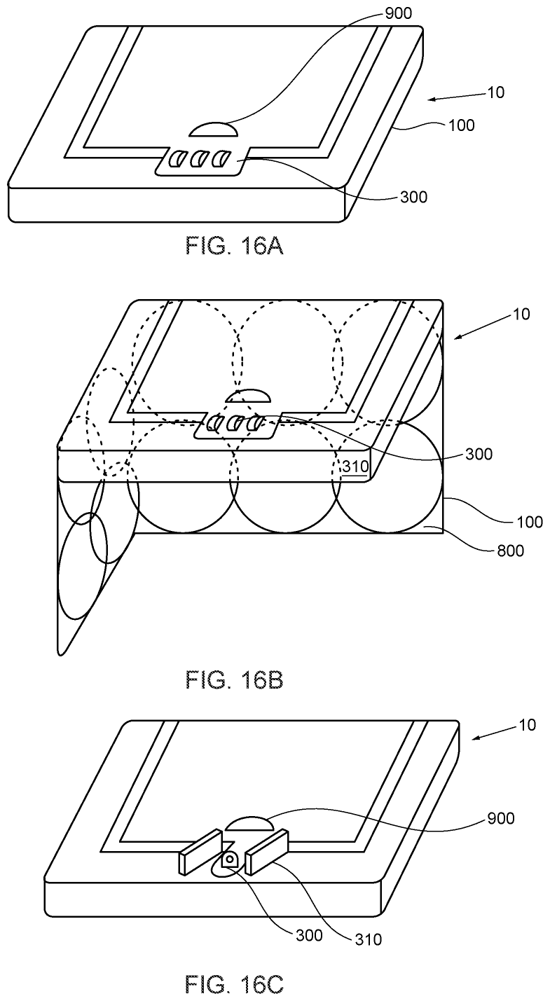

Referring now to FIGS. 16A to 16C, the locking assembly 300 in accordance with various embodiments are disclosed. As shown in FIG. 16A and 16B, the locking assembly 300 is incorporated the package receiving enclosure 100 of the package receiving device 10 to enable locking and unlocking of the package receiving enclosure by an authorized personal. FIG. 16A is showing the package receiving enclosure 100 in locked state locked by the locking assembly 300. FIG. 16B is showing the package receiving enclosure 100 in unlocked state, unlocked by the locking assembly 300. In unlocked state, the package receiving enclosure 100 is opened to receive the package in the expandable bag member 102 or the free□flowing looped-cable structure 800.

Further, in another embodiment, as shown in FIG. 16C, the locking assembly 300 may be protected via a protective wall 310. Such protective wall 310 may surrounds the locking assembly 300 to stop criminals from using bolt cutter to cut the locking assembly 300.

Further, in one embodiment of the present disclosure, the package receiving device 10 includes the package receiving/pickup information system 400 associated with the locking assembly 300, as shown in FIG. 1. The package receiving/pickup information system 400 may be adapted to be communicably coupled with at least the central server, and the at least one hand held device of the authorized personal to enable locking and unlocking of the package receiving enclosure by the authorized personal.

The present invention provides a system or a device for facilitating a package delivery at or a pickup from a door assembly of a building structure, which offers the various advantages. Most importantly, the device or the system is capable of receiving a mail parcel or package when the home owner is not home and hold the parcel securely so the parcel is not stolen. Such device is secure and simple and easy to use with any type of home or office front, small or big porch or with the home with no porch. Further, the package delivery and pick-up system, device and method of the present disclosure are configured to receive a mail parcel when the home owner is not home and hold the parcel securely so the parcel is not stolen. As the mail parcel thieves are on the dramatic increase as more and more people are now shopping online. Most of these thieves are not career criminals but opportunist criminals. The fact that the package is just sitting unprotected, is a signal to them that they can steal it. The package delivery and pick-up system, device and method provide a reason strong enough to keep people honest. The device may be small in size but can expand to accommodate and hold bigger boxes. Further, most people do not have enough space in front of their door to accommodate a large security box as they may live in an apartment or they do not want a large box in front of their door. In such scenario such device is very useful. Still, further, the device works for all types of housing types from larges homes to high rise apartments and businesses. The disclosed device has the ability to collapse into a smaller unit and be discrete. One of the major problems of the last mile delivery (from warehouse to final customers location) is gaining access to the apartment and high rise to deliver the parcels to the final customer. The associated method may advantageously fill these needs and addresses the aforementioned deficiencies by providing a cost-effective delivery method that allows a safe delivery of a package even when the owner is not home, this is a more cost-effective delivery method as a second delivery attempts and third attempts are not need, non-business hours delivery is now feasible and more secure and further lowers the cost of delivering batching of apartment deliveries. The device and system save time, money and resources. The device is also a very marketing tool. As the device popped up and received a package the device may become a very large door knocker advert.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

What is claimed is:

1. A system for facilitating a package delivery at or a pickup from a door assembly of a building structure, the door assembly having a door with a thickness, and a door jamb, the door hingedly coupled to the door jamb to define a door channel between the door and the door jamb, the system comprising:
a package receiving enclosure;
a securing arrangement coupled to the package receiving enclosure, wherein the securing arrangement is adapted to be received in the door channel between the door and the door jamb for detachably coupling the package receiving enclosure to the door assembly of the building structure; and
a locking assembly coupled to the package receiving enclosure to enable locking and unlocking of the package receiving enclosure by an authorized personal.

2. The system as claimed in claim 1 further comprising:
a package receiving/pickup information system associated with the locking assembly,
a central server;
at least one hand held device of the authorized personal, the at least one hand held device of the authorized personal including a delivery/pick-up personal hand-held device or a package owner hand-held device,
wherein the package receiving/pickup information system is adapted to be communicably coupled with at least the central server, and the at least one hand held device of the authorized personal to enable locking and unlocking of the package receiving enclosure by the authorized personal.

3. The system as claimed in claim 1, wherein the securing arrangement comprises:
a plate structure having
a first portion member detachably coupled to the package receiving enclosure,
a second portion member bends from first portion member, wherein the second portion member defines a length that compliments the thickness of the door, and
a third portion member bends from the second portion members, wherein the third portion member is substantially parallel and shorter in length than the first portion member,
wherein the first, second and third portions unitarily defines the plate structure, wherein the second and third portion members are adapted to be received in the door channel between the door and the door jamb such that the second portion member accommodate the thickness of the door and the third portion member along with the first portion member grips the door grips the door from an inside and an outside of the door for detachably coupling the package receiving enclosure to the door assembly.

4. The system as claimed in claim 3, wherein the plate structure comprises:
an attaching member coupled to the plate structure to detachably couple the plate structure to the door, wherein the attaching member is provided along the second portion member to detachably couple the plate structure to the door.

5. The system as claimed in claim I, wherein the securing arrangement comprises:
an attaching assembly having a set of screws, wherein the set of screws passes through the package receiving enclosure and adapted to be screwed in the door along the door channel for detachably coupling the package receiving enclosure to the door assembly.

6. The system as claimed in claim 1, wherein the securing arrangement comprises:
at least one chain and anchor assembly, the at least one chain and anchor assembly having:
a chain member, the chain member having a first end portion and a second end portion, the first end portion coupled to the package receiving enclosure;
an anchor member coupled to the second end portion of the chain member,
wherein the chain member is adapted to be received in the door channel such that the anchor member is disposed inside of the door assembly and the door act as stoppage for the anchor member for detachably coupling the package receiving enclosure to the door assembly.

7. The system as claimed in claim 1, wherein the package receiving enclosure is expandable to accommodate a package for delivery or pickup.

8. The system as claimed in claim 1, wherein the package receiving enclosure comprises:
a receptacle member having an enclosing space; and
an expandable bag member disposed within the receptacle member, wherein the expandable bag member is configured to be expanded to receive a package for delivery or pickup.

9. The system as claimed in claim 8, wherein the expandable bag member is adapted to be expanded upwardly from within the receptacle member to be expanded to receive the package for delivery or pickup.

10. The system as claimed in claim 8, wherein the expandable bag member is adapted to be expanded dropped downwardly from within the receptacle member to be expanded to receive the package for delivery or pickup.

11. The system as claimed in claim 8, wherein the expandable bag member comprises:
a free□flowing looped-cable structure having
a plurality of looped-cables interlocked with each other to define a free-flowing enclosure;
a supporting structure having one or more support member, wherein the plurality of looped-cables are coupled to the one or more support member to obtain the expandable bag member; and
a locking structure coupled to the free-flowing looped-cable structure, wherein the locking structure locks the free-flowing enclosure from an unauthorized access.

12. The system as claimed in claim 11, wherein the locking structure is a free-floating locking structure having a lock member.

13. The system as claimed in claim 8, wherein the receptacle member comprises a first enclosure member, and a second enclosure member pivotally coupled to the first enclosure member to define the enclosing space;

14. The system as claimed in claim 8, wherein the receptacle member comprises an expandable structure adapted to expand a size of the receptacle member to accommodate a package for delivery or pickup, wherein the expandable structure is adapted to expand the size of the receptacle member at least from one of a side, a top and a front of the receptacle member to accommodate the package for delivery or pickup.

15. A package receiving device fir facilitating package delivery at or pickup from a door assembly of a building structure, the door assembly having a door with a thickness, and a door jamb, the door hingedly coupled to the door jamb to define a door channel between the door and the door jamb, the package receiving device comprising:
a package receiving enclosure;
a securing arrangement coupled to the package receiving enclosure, wherein the securing arrangement is adapted to be received in the door channel between the door and the door jamb for detachably coupling the package receiving enclosure to the door assembly of the building structure; and
a locking assembly coupled to the package receiving enclosure to enable locking and unlocking of the package receiving enclosure by an authorized personal.

16. The package receiving device as claimed in claim 15 further comprising:
a package receiving/pickup information system associated with the locking assembly.

17. The package receiving device as claimed in claim 15, wherein the securing arrangement comprises:
a plate structure having
a first portion member detachably coupled to the package receiving enclosure,
a second portion member bends from first portion member, wherein the second portion member defines a length that compliments the thickness of the door, and
a third portion member bends from the second portion members, wherein the third portion member is substantially parallel and shorter in length than the first portion member,
wherein the first, second and third portions unitarily defines the plate structure, wherein the second and third portion members are adapted to be received in the door channel between the door and the door jamb such that the second portion member accommodate the thickness of the door and the third portion member along with the first portion member grips the door grips the door from an inside and an outside of the door for detachably coupling the package receiving enclosure to the door assembly.

18. The package receiving device as claimed in claim 16, wherein the plate structure comprises:
an attaching member coupled to the plate structure to detachably couple the plate structure to the door, wherein the attaching member is provided along the second portion member to detachably couple the plate structure to the door.

19. The package receiving device as claimed in claim 15, wherein the securing arrangement comprises:
an attaching assembly having a set of screws, wherein the set of screws passes through the package receiving enclosure and adapted to be screwed in the door along the door channel for detachably coupling the package receiving enclosure to the door assembly.

20. The package receiving device as claimed in claim 15, wherein the securing arrangement comprises:
at least one chain and anchor assembly, the at least one chain and anchor assembly having:
a chain member, the chain member having a first end portion and a second end portion, the first end portion coupled to the package receiving enclosure;
an anchor member coupled to the second end portion of the chain member,
wherein the chain member is adapted to be received in the door channel such that the anchor member is disposed inside of the door assembly and the door act as stoppage for the anchor member for detachably coupling the package receiving enclosure to the door assembly.

21. The package receiving device as claimed in claim 15, wherein the package receiving enclosure is expandable to accommodate a package for delivery or pickup, the package receiving enclosure comprising:
a receptacle member having an enclosing space; and
an expandable bag member disposed within the receptacle member, wherein the expandable bag member is configured to be expanded to receive a package for delivery or pickup, the expandable bag member comprising a free□flowing looped-cable structure having
a plurality of looped-cables interlocked with each other to define a free-flowing enclosure;
a supporting structure having a plurality of rod and frame members, wherein the plurality of looped-cables are coupled with the rod and frame members to obtain the expandable bag member; and
a locking structure coupled to the free-flowing looped-cable structure, wherein the locking structure locks the free-flowing enclosure from an unauthorized access,
wherein the expandable bag member is adapted to be expanded upwardly or dropped downwardly from within the receptacle member to be expanded to receive the package for delivery or pickup.
